(19) United States
(12) Patent Application Publication
(10) Pub. No.: US 2026/0104939 A1
(43) Pub. Date: Apr. 16, 2026

(54) PROGRAMMING OFFLOAD METHOD

(71) Applicant: Lenovo Enterprise Solutions (Singapore) Pte. Ltd., Singapore (SG)

(72) Inventors: Caihong Zhang, Shanghai (CN); Fred Allison Bower, III, Durham, NC (US); Gregory Pruett, Raleigh, NC (US)

(21) Appl. No.: 19/116,407

(22) PCT Filed: Jul. 21, 2023
(86) PCT No.: PCT/CN2023/108543

§ 371 Date: Mar. 28, 2025

(51) Int. Cl. G06F 9/50

(52) U.S. Cl. CPC G06F 9/5044; G06F 2209/5022; G06F 2209/509

(57) ABSTRACT

A programming offload method includes receiving a composition request for a new workload; determining whether to offload the new workload to a FPGA; selecting a compute node from a plurality of compute nodes and composing the selected compute node based on the composition request in response to not offloading the new workload to the FPGA; identifying an idling FPGA already programmed with a needed personality in a resource pool in response to offloading the new workload to the FPGA; and composing the selected compute node based on the composition request, and connecting the idling FPGA already programmed with the needed personality to the selected compute node.

### FIELD OF TECHNOLOGY

The present disclosure relates to the field of computing technology and, more specifically, to a programming offload method.

### BACKGROUND

In computing technology, field-programmable gate arrays (FPGAs) are commonly used as accelerators in conjunction with processors, such as central processing units (CPUs), to improve the overall system performance. In a composed environment, workloads can dynamically fluctuate in different times of a day. For example, in nighttime, the demand for quality of service (QoS) applications to manage data traffic to reduce packet loss can be high, while in daytime, the demand for internet protocol security (IPSec) applications to provide data authentication, integrity, and confidentiality can be high. FPGAs can be used to handle the fluctuation of workloads. However, in order for the FPGAs to accelerate/offload specific functions or tasks, the FPGAs first need to be programmed with the specific personalities.

A composed environment may include a plurality of FPGAs, and each FPGA may be programmable with specific personality to accelerate specific functions or tasks. For example, a first FPGA may be programmable with a personality to accelerate IPSec tasks while a second FPGA may be programmable with a personality to accelerate QoS tasks. In some cases, another copy of the first FPGA may be needed for a new workload in the composed environment or the hardware of the first FPGA may fail such that a backup FPGA is needed for the current workload. As such, it is necessary to identify a FPGA that is available and program (which involves transferring a substantial amount of data across the network to where the available FPGA is stored) the FPGA with the needed personality.

In conventional technology, if a specific workload in the composed environment has functions or tasks that need to be accelerated/offloaded, a configuration manager can identify a FPGA that is available, connect the identified FPGA to a compute node that is handling the specific workload, and the compute node can program the FPGA with the desired personality. As such, there is a programming delay on the availability of the FPGA, which can affect the performance of the compute node and the composed environment.

### BRIEF SUMMARY OF THE DISCLOSURE

An aspect of the present disclosure provides a programming offload method. The workload management method includes receiving a composition request for a new workload; determining whether to offload the new workload to a FPGA; selecting a compute node from a plurality of compute nodes and composing the selected compute node based on the composition request in response to not offloading the new workload to the FPGA; identifying an idling FPGA already programmed with a needed personality in a resource pool in response to offloading the new workload to the FPGA; and composing the selected compute node based on the composition request, and connecting the idling FPGA already programmed with the needed personality to the selected compute node.

Another aspect of the present disclosure provides a programming offload apparatus. The workload management apparatus a processor; and a memory storing one or more sets of instruction sets that, when executed by the processor, causes to the processor to receive a composition request for a new workload; determine whether to offload the new workload to a FPGA; select a compute node and compose the selected compute node based on the composition request in response to not offloading the new workload to the FPGA; identify an idling FPGA already programmed with a needed personality in a resource pool to offload the new workload in response to offloading the new workload to the idling FPGA; and select and compos the compute node based on the composition request, and connecting the idling FPGA already programmed with the needed personality to the selected compute node.

Another aspect of the present disclosure provides a composed environment. The composed environment includes a resource pool including a plurality of compute nodes and FPGAs; and a configuration manager configured to manage the composed environment by receiving a composition request for a new workload; determining whether to offload the new workload to a FPGA; selecting a compute node in the resource pool and composing the selected compute node based on the composition request in response to not offloading the new workload to the FPGA; identifying an idling FPGA already programmed with a needed personality in the resource pool to offload the new workload in response to offloading the new workload to the idling FPGA; and selecting and composing the compute node based on the composition request, and connecting the idling FPGA already programmed with the needed personality to the selected compute node.

### BRIEF DESCRIPTION OF THE DRAWINGS

In order to more clearly illustrate technical solutions in embodiments of the present disclosure, drawings for describing the embodiments are briefly introduced below. Obviously, the drawings described hereinafter are only some embodiments of the present disclosure, and it is possible for those ordinarily skilled in the art to derive other drawings from such drawings without creative effort.

FIG. 1A is a diagram of a composed environment according to an embodiment of the present disclosure;

FIG. 1B is a diagram of another composed environment according to an embodiment of the present disclosure;

FIG. 2 is a flowchart of a programming offload method according to an embodiment of the present disclosure;

FIG. 3 is a flowchart of another programming offload method according to an embodiment of the present disclosure;

FIG. 4 is a flowchart of yet another programming offload method according to an embodiment of the present disclosure; and

FIG. 5 is a structural diagram of a programming offload apparatus according to an embodiment of the present disclosure.

### DETAILED DESCRIPTION

The technical solutions provided by the present disclosure according to various embodiments are described below with reference to the drawings. The described embodiments are only part of the embodiments of the present disclosure. Other embodiments acquired by a person of ordinary skill in the art based on the described embodiments without departing from the spirit of the disclosure are the within scope of the present disclosure. It should be understood that such description is illustrative only but is not intended to limit the scope of the present disclosure. In addition, in the following description, known structures and technologies are not described to avoid unnecessary obscuring of the present disclosure.

The terms used herein is for the purpose of describing particular embodiments only, but is not intended to limit the present disclosure. The terms such as “comprising”, “including”, “containing” and the like as used herein indicate the presence of the features, steps, operations and/or components, but do not preclude the presence or addition of one or more other features, steps, operations or components.

All terms (including technical and scientific terms) used herein have the same meanings as commonly understood by the skilled in the art, unless defined otherwise. It should be noted that the terms used herein should be construed to have the same meanings as the context of the present disclosure and should not be interpreted in an idealized or overly stereotyped manner.

In terms of a statement such as “at least one of A, B, and C, etc.,” it should be generally interpreted in light of the ordinary understanding of the expression by those skilled in the art. For example, “a system including at least one of A, B, and C” shall include, but is not limited to, a system including A alone, a system including B alone, a system including C alone, a system including A and B, a system including A and C, a system including B and C, and/or a system including A, B, and C, etc. In terms of a statement similar to “at least one of A, B or C, etc.”, it should generally be interpreted in light of the ordinary understanding of the expression by those skilled in the art. For example, “a system including at least one of A, B or C” shall include, but is not limited to, a system including A alone, a system including B alone, a system including C alone, a system including A and B, a system including A and C, a system including B and C, and/or a system including A, B, and C, etc.

A few block diagrams and/or flowcharts are shown in the accompanying drawings. It should be understood that some of the blocks or combinations thereof in the block diagrams and/or flowcharts may be implemented by computer executable instructions. The computer executable instructions may be provided to a general purpose computer, a dedicated computer, or processors of other programmable data processing apparatus, so that the instructions, when being executed by the processor, may create means for implementing the functions/operations as described in the block diagrams and/or flowcharts.

Thus, the techniques of the present disclosure may be implemented in forms of hardware and/or software (including firmware, microcode, etc.). In addition, the techniques of the present disclosure may be embodied in a form of computer program instructions stored in a computer readable medium. The computer program instructions may be used by an instruction execution system or in conjunction with an instruction execution system. In the context of the present disclosure, the computer readable medium may be any medium capable of containing, storing, transmitting, propagating, or transmitting instructions. For example, the computer readable media may include, but are not limited to, electrical, magnetic, optical, electromagnetic, infrared or semiconductor systems, apparatuses, devices, or propagation media. Particular examples of the computer readable media may include a magnetic storage device, such as a magnetic tape or a hard drive disk (HDD); an optical storage device, such as an optical disk (CD-ROM); a memory, such as a random access memory (RAM) or a flash memory; and/or a wired/wireless communication link.

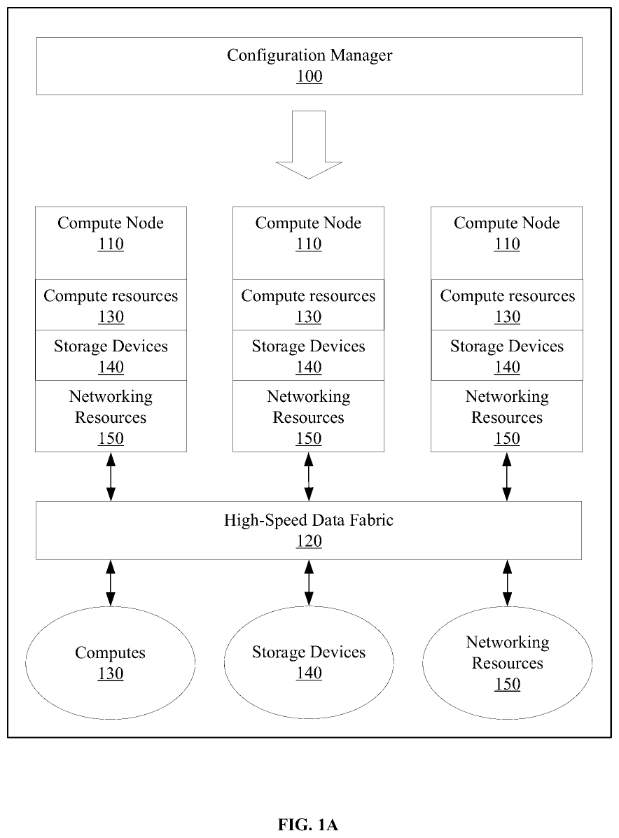

FIG. 1A is a diagram of a composed environment according to an embodiment of the present disclosure.

As shown in FIG. 1, a composed environment includes a configuration manager 100, a plurality of compute nodes 110, and a plurality of high-speed data fabrics 120. The configuration manager can be used to manage the composed environment by interconnecting various parts of the composed environment to complete various workloads. Each of compute nodes may include one or more compute resources 130, one or more storage devices 140, and one or more networking resources 150. The one or more compute resources 130, one or more storage devices 140, and one or more networking resources 150 are shared resources and may be used by one or more compute nodes 110 in the composed environment. As such, the combination of the one or more compute resources 130, one or more storage devices 140, and one or more networking resources 150 may be considered as a resource pool. Since not all shared resources may be used at all times, some of the shared resources may be with the one or more compute nodes 110 while the rest of the shared resources may be in the resource pool. The configuration manager 100 is connected to the compute nodes 110, and one or more of the shared resources may be connected to each of the compute nodes 110 through the high-speed data fabric 120.

The configuration manager 100 can send a composition request to one or more of the compute nodes 110. After receiving the composition request, the one or more compute nodes 110 can connect to shared resources, such as one or more of the compute resources 130, storage devices 140, and networking resources 150, through the high-speed data fabric 120 based on the composition request to compose the one or more compute nodes 110. As such, the one or more compute nodes 110 can be composed on demand to handle specific workloads. When the specific workloads are completed, the shared resources used by the one or more compute nodes 110 can be released back to the resource pool for use by another compute node.

In some embodiments, the compute nodes 110 may include, but are not limit to, one or more of personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

In some embodiments, the high-speed data fabric 120 may include, for example, a 100 GB Ethernet, an infiniband, or an optical interconnect to provide data links between the shared resources and the compute nodes 110. As such, the compute nodes 110 can be composed from the available resources in the resource pool.

In some embodiments, the compute resource 130 may include a processor, a FPGA, an application specific integrated circuit (ASIC) microcontroller, or the like to perform computational tasks.

FIG. 1B is a diagram of another composed environment according to an embodiment of the present disclosure.

As shown in the FIG. 1B, the configuration manager 100 may be a computer program stored in a memory in each of the one or more compute nodes 110. The configuration manager 100 may be executed by a processor installed in each of the one or more compute nodes 110 to handle tasks related to the configuration of the respective compute node. In some embodiments, the compute nodes 110 may be various grouping of processors in a server or a plurality of servers, however, the present disclosure is not limited thereto.

One aspect of the present disclosure provides a programming offload method in which a configuration manager can identify a FPGA that is already programmed with the needed personality in the resource pool when a FPGA is needed to accelerate a workload. As such, the efficiency in composing the compute node can be improved by reducing the programming delay on the availability of the FPGA, thereby improving the performance of the compute node and the composed environment.

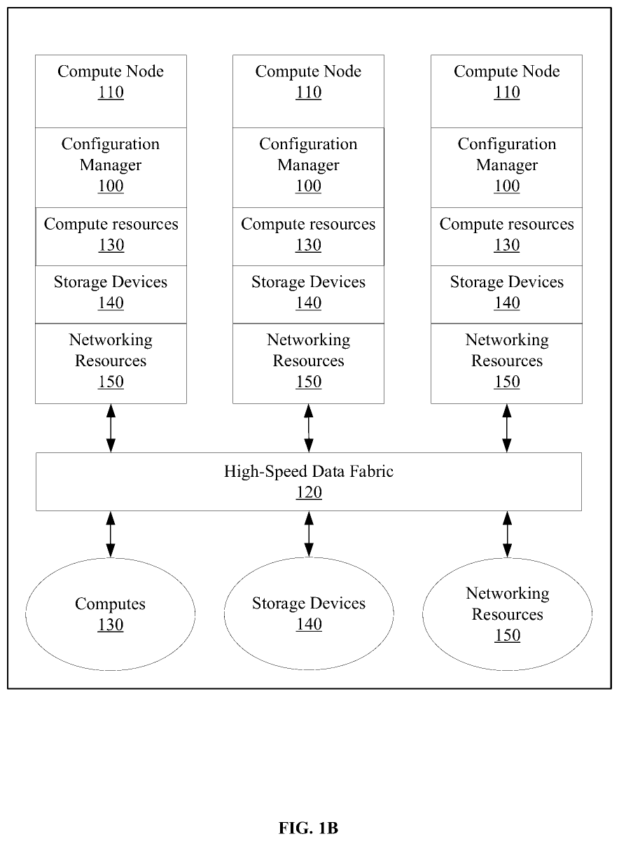

FIG. 2 is a flowchart of a programming offload method according to an embodiment of the present disclosure. The programming offload method will be described in detail below.
S201, receiving a composition request for a new workload.

In the composed environment, the configuration manger can receive a composition request and compose a compute node based on the composition request to perform a workload. More specifically, the configuration manager can select a compute node for composition from the plurality of compute nodes based on the composition request, and available resources, that is, one or more compute resources, one or more storage devices, and one or more networking resources in the resource pool can be connected to the selected compute node to complete a specific workload. For example, if a specific workload needs two storage devices and three networking resources to complete, the configuration manager can issue a composition request including this need to the selected compute node that can handle the specific workload, identify two storage devices and at least three networking resources from the resource pool, and connect the two storage devices and three networking resources to the selected compute node to complete the specific workload.

In some embodiments, the composition request may include, but is not limited to, one or more of the type of resources, amount of resources, or expected working duration of resources to complete specific workloads. For example, the composition request may specify that two storage devices and three networking resources are needed for 30 minutes to complete a specific workload. As such, the configuration manager can track the usage of the resources, thereby improving the resource planning of the overall computing system.
S202, determining whether to offload the new workload to a FPGA based on a type of the new workload or a workload processing efficiency gained by offloading the new workload to the FPGA.

In some embodiments, after the configuration manager receives the new workload composition request, the configuration manager can determine whether to offload the new workload to a FPGA based on the type of the new workload. In general, FPGAs are well-suited to perform application specific functions or algorithms. On one hand, due to the structure of FPGAs, FPGAs are particular suitable for tasks that involve a high degree of parallel processing. On the other hand, due to the high clock speed of CPUs, CPUs are particular suitable for tasks that involve sequential processing. For example, in the field of image processing, FPGAs are particular suitable for filtering and color extraction, while CPUs are particular suitable for pattern matching and optical character recognition (OCR). Therefore, the configuration manager can determine whether to offload the new workload to FPGA based on the type of the new workload.

In some embodiments, after the configuration manager receives the new workload composition request, the configuration manager can determine whether to offload the new workload to a FPGA based on a workload processing efficiency gained by offloading the new workload to the FPGA. For example, the configuration manager can calculate the workload processing efficiency gained by offloading the new workload to the FPGA, if the workload processing efficiency gained by offloading the new workload to the FPGA is above a first efficiency threshold, such as 50%, the configuration manager may offload the new workload to the FPGA. Conversely, if the workload processing efficiency gained by offloading the new workload to the FPGA is below a second efficiency threshold, such as 30%, the configuration manager may not offload the new workload to the FPGA. More specifically, the efficiency thresholds can be set based on actual needs, which is not limited in the present disclosure.
S203, selecting a compute node from a plurality of compute nodes and composing the selected compute node based on the composition request in response to not offloading the new workload to the FPGA.

If the configuration manager determines not to offload the new workload to the FPGA based on the type of the new workload or the workload processing efficiency gained by offloading the new workload to the FPGA, the configuration manager may select a compute node for composition from the plurality of compute nodes based on the composition request, and connect the needed resources, that is, one or more compute resources, one or more storage devices, and one or more networking resources in the resource pool to the selected compute node to compose the compute node to complete the new workload. For example, the configuration manager may select a compute node having an available processing capacity of the computing resources exceeds a certain threshold such that the available processing capacity is sufficient to process the new workload without affecting the state of the currently assigned workloads.
S204, identifying an idling FPGA already programmed with a needed personality in a resource pool in response to offloading the new workload to the FPGA.

If the configuration manager determines to offload the new workload to the FPGA based on the type of the new workload or the workload processing efficiency gained by offloading the new workload to the FPGA, the configuration manager may further identify an idling FPGA already programmed with a needed personality to accelerate the new workload. Since there are a plurality of FPGAs in the resource pool, one of the plurality of FPGAs in the resource pool that is idling may be already programmed with the personality needed by the new workload that can be used to accelerate the new workload.

For example, assuming there are two idling FPGAs in the resource pool, where a first FPGA may be programmed with an IPSec personality, and a second FPGA may be programmed with the QoS personality. If the configuration manager receives an IPSec-related workload composition request and determines that the workload can be offload to a FPGA, the configuration manager may identify the first idling FPGA from the resource pool and use it to accelerate the IPSec-related workload. By using the FPGA in the resource pool already programmed with the needed personality, the selected compute node does not need to program the FPGA. As such, the efficiency in composing the compute node can be improved by reducing the programming delay on the availability of the FPGA, thereby improving the performance of the compute node and the composed environment.
S205, composing the selected compute node based on the composition request, and connecting the idling FPGA already programmed with the needed personality to the selected compute node.

After the configuration manager identifies the idling FPGA already programmed with the personality needed by the new workload, the configuration manager may select and compose a compute node based on the composition request, and connect the idling FPGA already programmed with the needed personality to the selected compute node to accelerate the new workload. For the method of selecting a compute node in the composable state and connecting available resources to the selected compute node, reference may be made to the description of S203 above, which will not be repeated herein again.

In some embodiments, an idling FPGA may include, but is not limited to, a FPGA in the resource pool that is not connected to a workload, or a FPGA in the resource pool that is already connected to a workload, but has completed the acceleration of the connected workload. On one hand, if the idling FPGA is not attached to a workload, then the configuration manager may connect the idling FPGA directly to the selected compute node to accelerate the new workload. On the other hand, if the idling FPGA is already connected to a workload, the programming offload method of the present disclosure may further include disconnecting the idling FPGA from a current workload before connecting the idling FPGA to the selected compute node. In this case, after the idling FPGA is disconnected from the current workload, the configuration manager may connect the idling FPGA to the selected compute node to accelerate the new workload.

By using the programming offload method described above, the configuration manager may receive a composition request for a new workload, and determine whether to offload the new workload to a FPGA based on a type of the new workload or a workload processing efficiency gained by offloading the new workload to the FPGA. Further, the configuration manager may select a compute node from a plurality of compute nodes and compose the selected compute node based on the composition request in response to not offloading the new workload to the FPGA. Alternatively, the configuration manager may identify an idling FPGA already programmed with a needed personality in a resource pool in response to offloading the new workload to the FPGA. Subsequently, the configuration manager may compose the selected compute node based on the composition request and connect the idling FPGA already programmed with the needed personality to the selected compute node to accelerate the workload. As such, the efficiency in composing the compute node can be improved by reducing the programming delay on the availability of the FPGA, thereby improving the performance of the compute node and the composed environment.

Due to the high cost and high power consumption of FPGAs, in general, the FPGAs in the composed environment are being used (that is, connected to a workload to accelerate the workload) at all times. Therefore, identifying an idling FPGA in the resource pool already programmed with the needed personality may be less likely than identifying a FPGA in the resource pool already programmed with the needed personality that is currently being used to accelerate a workload. As such, an embodiment of the present disclosure provides another programming offload method which may be used to identify a FPGA already programmed with the needed personality and connected to a workload in the resource pool to accelerate the new workload.

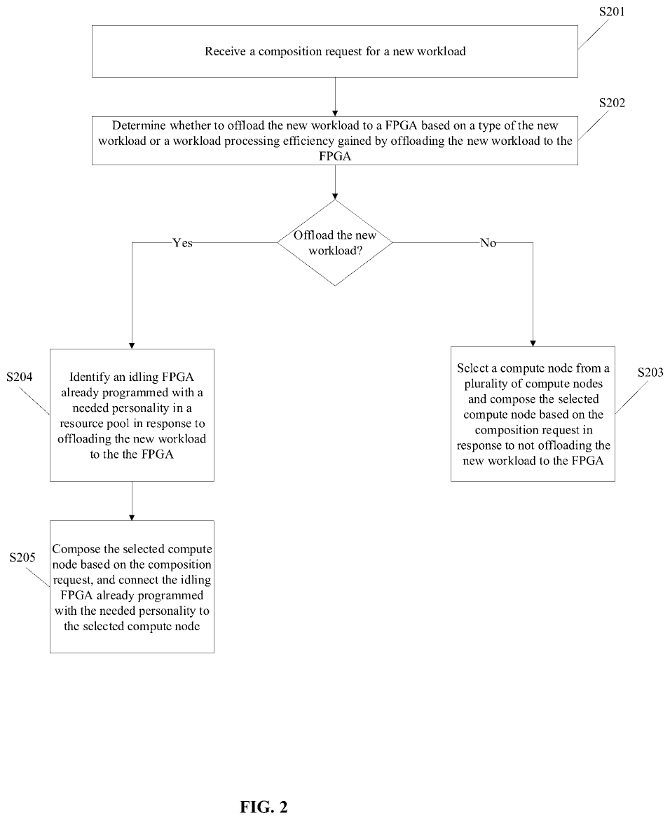

FIG. 3 is a flowchart of another programming offload method according to an embodiment of the present disclosure. The programming offload method will be described in detail below.
S301, identifying a first non-idling FPGA already programmed with the needed personality in the resource pool.

If the configuration manager determines to offload the new workload to the FPGA, it would be ideal for the configuration manager to identify an idling FPGA already programmed with the needed personality in the resource pool to offload the new workload. However, as described above, it is unlikely to be able to identify an idling FPGA already programmed with the needed personality, thus, it may be necessary to identify a non-idling FPGA already programmed with the needed personality in the resource pool. In some embodiments, the non-idling FPGA may include, but is not limited to, a FPGA that is currently connected to a workload and is accelerating the workload.
S302, determining a computing capacity of the first non-idling FPGA already programmed with the needed personality.

Since the non-idling FPGA already programmed with the needed personality may be accelerating a current workload, after the configuration manager identifies the first non-idling FPGA in the resource pool, it may be necessary to determine the computing capacity of the first non-idling FPGA to ensure that the non-idling FPGA has sufficient computing capacity to accelerate the new workload.

In some embodiments, the computing capacity of the non-idling FPGA may be determined by the configuration manager actively querying the non-idling FPGA. For example, when the configuration manager identifies the non-idling FPGA, the configuration manager may send a query to the non-idling FPGA to check the computing capacity of the non-idling FPGA. In response to receiving the query from the configuration manager, the non-idling FPGA may report its computing capacity to the configuration manager.

In some embodiments, the computing capacity of the non-idling FPGA may be determined by the non-idling FPGA actively reporting its computing capacity to the configuration manager in response to a condition being satisfied. The condition may include, but is not limited to, the workload currently being accelerated by the non-idling FPGA is completed, or a set portion of the workload currently being accelerated by the non-idling FPGA is completed. For example, the non-idling FPGA may report its computing capacity to the configuration manager when 90% of the currently accelerated by the non-idling FPGA is completed.
S303, connecting the first non-idling FPGA already programmed with the needed personality to the selected compute node in response to the computing capacity of the first non-idling FPGA exceeding a computing capacity threshold.

If the configuration manager determines that the first non-idling FPGA has sufficient computing capacity to accelerate the new workload, the configuration manager may connect the first non-idling FPGA already programmed with the needed personality to the selected compute node to accelerate the new workload. For example, if the first non-idling FPGA has 50% of the overall computing capacity remaining and the new workload only needs 30% of the computing capacity of the overall computing capacity of the first non-idling FPGA, the configuration manager may connect the first non-idling FPGA to the selected compute node to accelerate the new workload.
S304, syncing a usage of the first non-idling FPGA already programmed with the needed personality between a current workload and the new workload.

After the configuration manager connects the first non-idling FPGA already programmed with the needed personality to the selected compute node, the first non-idling FPGA may accelerate the new workload. However, since the first non-idling FPGA is also being used to accelerate another workload (that is, the workload the non-idling FPGA is accelerating before being connected to the new workload) at the same time, it may be necessary to sync the usage of the current workload and the new workload to ensure the first non-idling FPGA is not being oversubscribed. An oversubscribed FPGA may be a FPGA that has taken on additional processing tasks exceeding its processing bandwidth, which can affect the overall performance of the workloads being accelerated by the FPGA.
S305, identifying a second non-idling FPGA already programmed with the needed personality in the resource pool in response to the computing capacity of the first non-idling FPGA is below the computing capacity threshold.

If the configuration manager determines that the first non-idling FPGA does not have sufficient computing capacity to accelerate the new workload, the configuration manager may identify a second non-idling FPGA already programmed with the needed personality in the resource pool to accelerate the new workload. For example, if the first non-idling FPGA has 50% of the overall computing capacity remaining and the new workload needs 75% of the computing capacity of the overall computing capacity of the first non-idling FPGA, the configuration manager may identify a second non-idling FPGA already programmed with the needed personality in the resource pool. After the configuration manager identifies the second non-idling FPGA already programmed with the needed personality in the resource pool, the configuration manager may perform S302 to S304 to ensure that the second non-idling FPGA has sufficient amount of computing capacity remaining to accelerate the new workload.

By using the programming offload method described above, the configuration manager may identify a first non-idling FPGA already programmed with the needed personality in the resource pool, determine a computing capacity of the first non-idling FPGA already programmed with the needed personality, connect the first non-idling FPGA already programmed with the needed personality to the selected compute node in response to the computing capacity of the first non-idling FPGA exceeding a certain threshold, and sync the usage of the first non-idling FPGA already programmed with the needed personality between the current workload and the new workload. Alternatively, the configuration manager may identify a second non-idling FPGA already programmed with the needed personality in the resource pool in response to the computing capacity of the first non-idling FPGA is below a certain threshold. As such, the performance of the FPGA can be ensured, and the overall performance of the computing environment can be improved.

Even though there are a plurality of FPGAs in the composed environment, there may still be situations where none of the FPGAs is already programmed with the personality that the new workload can use. For example, in nighttime, the demand for QoS applications may be high as most users may be steaming videos or playing online games. As such, most of the FPGAs in the composed environment may be programmed with the personality to accelerate QoS applications, and only a few FPGAs may be programmed with the personality to accelerate other applications, such as IPSec applications, and these FPGAs may be operating at full capacity to accelerate all of the IPSec workloads in the composed environment. At this time, if the configuration manager receives an IPSec-related new workload and determines to offload the new workload to a FPGA, the configuration manager may not be able to identify a FPGA already programmed with the personality to accelerate the new workload. As such, an embodiment of the present disclosure further provides another programming offload method which may be used to identify a FPGA to offload the new workload when there is no FPGA already programmed with the needed personality in the resource pool to accelerate the new workload.

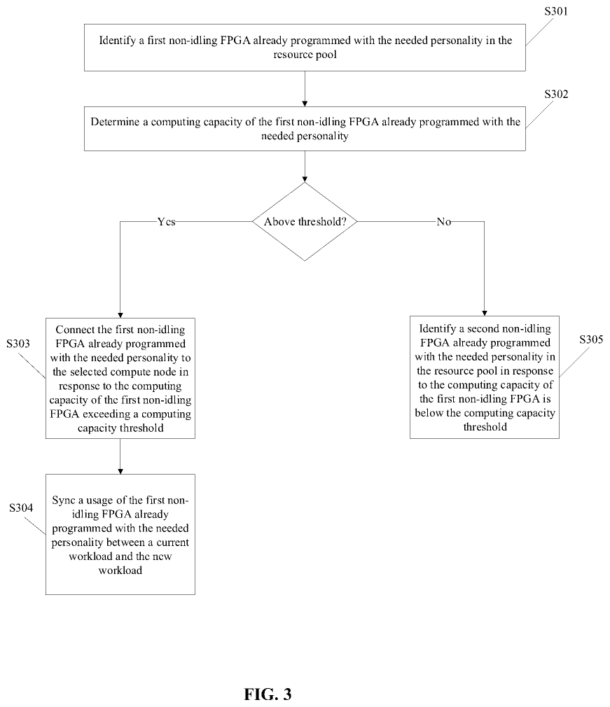

FIG. 4 is a flowchart of yet another programming offload method according to an embodiment of the present disclosure. The programming offload method will be described in detail below.
S401, identifying an idling FPGA not programmed with the needed personality in the resource pool.

As described above, if there is no FPGA already programmed with the needed personality in the resource pool to accelerate the new workload, the configuration manager may need to identify an idling FPGA not programmed with the needed personality and program the idling FPGA with the needed personality to accelerate the new workload.
S402, acquiring the needed personality from a FPGA already programmed with the needed personality or a personality database.

The selected compute node can be used to program the idling FPGA with the needed personality, however, in this case, the FPGA needs to be connected to the selected compute node first, then the selected compute node can program the FPGA. As such, there is a programming delay before the FPGA can be used to accelerate the new workload. Therefore, it may be more efficient for the configuration manager to program the FPGA before connecting the FPGA to the selected compute node.

The configuration manager may program the idling FPGA by identifying a FPGA already programmed with the needed personality or acquiring the needed personality from a personality database, and performing a target-to-target transfer of the needed personality from the FPGA already programmed with the needed personality or the personality database to the idling FPGA. As such, the programming efficiency of the idling FPGA may be improved.
S403, transferring the needed personality from the FPGA already programmed with the needed personality or the personality database to the idling FPGA not programmed with the needed personality.

After the configuration manager acquires the needed personality from the FPGA already programmed with the needed personality or the personality database, the configuration manager may perform a target-to-target transfer of the needed personality from the FPGA already programmed with the needed personality or the personality database to the idling FPGA, thereby programming the idling FPGA with the needed personality.
S404, connecting the idling FPGA programmed with the needed personality to the selected compute node.

After the configuration manager programs the idling FPGA, the configuration manager may connect the idling FPGA programmed with the needed personality to the selected compute node to accelerate the new workload.

By using the programming offload method described above, the configuration manager may identify an idling FPGA not programmed with a needed personality in the resource pool, identify a FPGA already programmed with the needed personality or acquire the needed personality from a personality database, transfer the needed personality from the FPGA already programmed with the needed personality or the personality database to the idling FPGA, and connect the idling FPGA with the needed personality to the selected compute node. As such, the delay in programming the FPGA can be reduced, and the overall performance of the computing environment can be improved.

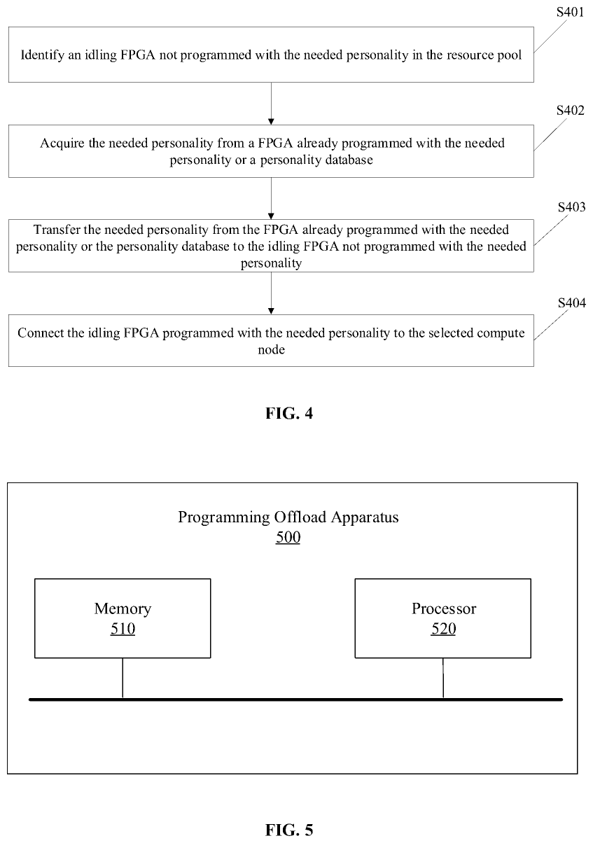

FIG. 5 is a structural diagram of a programming offload apparatus according to an embodiment of the present disclosure. The programming offload apparatus 500 is configured to perform a method consistent with the present disclosure, such as one of the example methods described in this disclosure. As shown in FIG. 5, the programming offload apparatus 500 includes a memory 510 storing a computer program and a processor 520 configured to execute the computer program to perform part or all of a method consistent with the present disclosure, such as one of the example methods described in this disclosure.

The memory 510 can include a computer readable storage medium, which can include at least one of a static random access memory (SRAM), a dynamic random access memory (DRAM), an erasable programmable read only memory (EPROM), an electrically erasable programmable read-only memory (EEPROM), or a flash memory such as a USB memory.

The processor 520 may include a general-purpose microprocessor, an instruction set processor, and/or a related chipset and/or a special purpose microprocessor (e.g., an application specific integrated circuit (ASIC)), and the like. Processor 420 may also include an onboard memory for caching purposes. Alternatively, the processor 420 may be a single processing unit or a plurality of processing units for performing different acts of a method flow according to certain embodiments of the present disclosure.

In some embodiments, the processor 520 may be configured to execute the computer program stored in the memory 510 to receive a composition request for a new workload, and determine whether to offload the new workload to a FPGA based on a type of the new workload or a workload processing efficiency gained by offloading the new workload to the FPGA. Further, the processor 520 may be configured to select a compute node from a plurality of compute nodes and compose the selected compute node based on the composition request in response to not offloading the new workload to the FPGA. Alternatively, the processor 520 may be configured to identify an idling FPGA already programmed with a needed personality in a resource pool in response to offloading the new workload to the FPGA. Subsequently, the processor 520 may be configured to compose the selected compute node based on the composition request and connect the idling FPGA already programmed with the needed personality to the selected compute node to accelerate the workload. As such, the efficiency in composing the compute node can be improved by reducing the programming delay on the availability of the FPGA, thereby improving the performance of the compute node and the composed environment.

In some embodiments, after the processor 520 receives the new workload composition request, the processor 520 can determine whether to offload the new workload to a FPGA based on the type of the new workload. In general, FPGAs are well-suited to perform application specific functions or algorithms. On one hand, due to the structure of FPGAs, FPGAs are particular suitable for tasks that involve a high degree of parallel processing. On the other hand, due to the high clock speed of CPUs, CPUs are particular suitable for tasks that involve sequential processing. For example, in the field of image processing, FPGAs are particular suitable for filtering and color extraction, while CPUs are particular suitable for pattern matching and optical character recognition (OCR). Therefore, the processor 520 can determine whether to offload the new workload to FPGA based on the type of the new workload.

In some embodiments, after the processor 520 receives the new workload composition request, the processor 520 can determine whether to offload the new workload to a FPGA based on a workload processing efficiency gained by offloading the new workload to the FPGA. For example, the processor 520 can calculate the workload processing efficiency gained by offloading the new workload to the FPGA, if the workload processing efficiency gained by offloading the new workload to the FPGA is above a first efficiency threshold, such as 50%, the processor 520 may offload the new workload to the FPGA. Conversely, if the workload processing efficiency gained by offloading the new workload to the FPGA is below a second efficiency threshold, such as 30%, the processor 520 may not offload the new workload to the FPGA. More specifically, the efficiency thresholds can be set based on actual needs, which is not limited in the present disclosure.

In some embodiments, an idling FPGA may include, but is not limited to, a FPGA in the resource pool that is not connected to a workload, or a FPGA in the resource pool that is already connected to a workload, but has completed the acceleration of the connected workload. On one hand, if the idling FPGA is not attached to a workload, then the processor 520 may connect the idling FPGA directly to the selected compute node to accelerate the new workload. On the other hand, if the idling FPGA is already connected to a workload, the processor 520 may be further configured to disconnect the idling FPGA from a current workload before connecting the idling FPGA to the selected compute node. In this case, after the idling FPGA is disconnected from the current workload, the processor 520 may connect the idling FPGA to the selected compute node to accelerate the new workload.

Due to the high cost and high power consumption of FPGAs, in general, the FPGAs in the composed environment are being used (that is, connected to a workload to accelerate the workload) at all times. Therefore, identifying an idling FPGA in the resource pool already programmed with the needed personality may be less likely than identifying a FPGA in the resource pool already programmed with the needed personality that is currently being used to accelerate a workload.

As such, the processor 520 may be configured to execute the computer program stored in the memory 510 to identify a first non-idling FPGA already programmed with the needed personality in the resource pool, determine a computing capacity of the first non-idling FPGA already programmed with the needed personality, connect the first non-idling FPGA already programmed with the needed personality to the selected compute node in response to the computing capacity of the first non-idling FPGA exceeding a certain threshold, and sync the usage of the first non-idling FPGA already programmed with the needed personality between the current workload and the new workload. Further, the processor 520 may be further configured to identify a second non-idling FPGA already programmed with the needed personality in the resource pool in response to the computing capacity of the first non-idling FPGA is below a certain threshold. As such, the performance of the FPGA can be ensured, and the overall performance of the computing environment can be improved.

In some embodiments, the computing capacity of the non-idling FPGA may be determined by the processor 520 actively querying the non-idling FPGA. For example, when the processor 520 identifies the non-idling FPGA, the processor 520 may send a query to the non-idling FPGA to check the computing capacity of the non-idling FPGA. In response to receiving the query from the processor 520, the non-idling FPGA may report its computing capacity to the processor 520.

In some embodiments, the computing capacity of the non-idling FPGA may be determined by the non-idling FPGA actively reporting its computing capacity to the processor 520 in response to a condition being satisfied. The condition may include, but is not limited to, the workload currently being accelerated by the non-idling FPGA is completed, or a set portion of the workload currently being accelerated by the non-idling FPGA is completed. For example, the non-idling FPGA may report its computing capacity to the processor 520 when 90% of the currently accelerated by the non-idling FPGA is completed.

Even though there are a plurality of FPGAs in the composed environment, there may still be situations where none of the FPGAs is already programmed with the personality that the new workload can use. For example, in nighttime, the demand for QoS applications may be high as most users may be steaming videos or playing online games. As such, most of the FPGAs in the composed environment may be programmed with the personality to accelerate QoS applications, and only a few FPGAs may be programmed with the personality to accelerate other applications, such as IPSec applications, and these FPGAs may be operating at full capacity to accelerate all of the IPSec workloads in the composed environment. At this time, if the processor 520 receives an IPSec-related new workload and determines to offload the new workload to a FPGA, the processor 520 may not be able to identify a FPGA already programmed with the personality to accelerate the new workload.

As such, the processor 520 may be configured to execute the computer program stored in the memory 510 to identify an idling FPGA in the resource pool not programmed with a needed personality, identify a FPGA already programmed with the needed personality or acquire the needed personality from a personality database, transfer the needed personality from the FPGA already programmed with the needed personality or the personality database to the idling FPGA, and connect the idling FPGA with the needed personality to the selected compute node. As such, the delay in programming the FPGA can be reduced, and the overall performance of the computing environment can be improved.

As will be appreciated by one skilled in the art, aspects of the present disclosure may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

According to the embodiments of the present disclosure, the processor 520 may interact with the computer readable storage medium to execute the method or any other variation thereof according to the embodiments of the present disclosure.

It will be appreciated by those skilled in the art that the variations and/or combinations of the various embodiments of the present disclosure and/or the claims may be made, even if such variations or combinations are not explicitly described in the present disclosure. In particular, various combinations of the features described in the various embodiments and/or claims of the present disclosure can be made without departing from the spirit and scope of the disclosure. All such combinations fall within the scope of the disclosure.

Although the present disclosure has been shown and described with respect to the specific exemplary embodiments, it will be understood by those skilled in the art that various changes in form and detail can be made to the present disclosure. Therefore, the scope of the present disclosure should not be limited to the forgoing described embodiments, but should be determined not only by the appended claims but also by the equivalents of the appended claims.

1-20. (canceled)

21. A computer program product comprising a non-transitory computer readable medium and program instructions embodied therein, the program instructions being configured to be executable by a processor to cause the processor to perform operations for managing assignment of field-programmable gate arrays (FPGAs) in a composed computing environment, the operations comprising:
receiving, by a configuration manager, a composition request for a new workload;
identifying a workload type of the new workload;
calculating a workload processing efficiency metric representing an expected performance improvement gained by offloading the new workload to a FPGA compared to processing the new workload using a central processing unit (CPU);
generating an offloading decision indicating either to offload the new workload to a FPGA in response to the workload processing efficiency metric meeting or exceeding a predetermined efficiency threshold, or to not offload the new workload to the FPGA in response to the workload processing efficiency metric failing to exceed the predetermined efficiency threshold;
selecting and configuring a compute note in response to the offloading decision, wherein:
when the offloading decision indicates to offload the new workload to an FPGA, configuring the compute node comprises identifying, from a resource pool comprising a plurality of FPGAs, a FPGA that is programmed with a personality and that is determined to have capacity to accelerate the new workload, the personality providing a functional capability to accelerate the new workload and being selected from a plurality of personalities based on the new workload, and connecting the FPGA programmed with the personality to the selected compute node; and
when the offloading decision indicates not to offload the new workload to an FPGA, configuring the compute node comprises composing, by the configuration manager, the selected compute node with required resources enabling the selected compute node to process the new workload without FPGA acceleration; and
causing the configured compute node to process the new workload.

22. The computer program product of claim 21, wherein identifying that the workload type of the new workload is able to be accelerated by an FPGA includes:
calculating a workload processing efficiency to be gained by offloading the new workload;
generating the offloading decision indicating to offload the new workload in response to the calculated gain in workload processing efficiency exceeding a first threshold; and
generating the offloading decision indicating to not offload the new workload in response to the calculated gain in workload processing efficiency being below a second threshold.

23. The computer program product of claim 21, further comprising:
identifying, in response to generating the offloading decision indicating to offload the new workload, a field-programmable gate array within the resource pool that is not programmed with the personality that will accelerate the new workload but has sufficient capacity to accelerate the new workload;
acquiring the personality; and
causing the selected compute node to program the identified field-programmable gate array with the acquired personality after connecting the identified specific field-programmable gate array to the selected compute node.

24. The computer program product of claim 23, wherein the operation of identifying, in response to generating the offloading decision indicating to offload the new workload, a field-programmable gate array within the resource pool that is not programmed with the personality that will accelerate the new workload but has sufficient capacity to accelerate the new workload is performed only if a field-programmable gate array within the resource pool that is already programmed with the personality that will accelerate the new workload and is determined to have sufficient capacity to accelerate the new workload cannot be identified.

25. The computer program product of claim 21, wherein the FPGA is programmed with the personality prior to the connecting of the FPGA to the selected compute node.

26. The computer program product of claim 25, further comprising:
identifying, in response to generating the offloading decision indicating to offload the new workload, a field-programmable gate array within the resource pool that is not programmed with the personality that will accelerate the new workload but has sufficient capacity to accelerate the new workload;
acquiring the personality; and
programming the identified field-programmable gate array with the acquired personality before connecting the identified specific field-programmable gate array to the selected compute node.

27. The computer program product of claim 26, wherein the personality is acquired from one of the plurality of field-programmable gate arrays in the resource pool that is already programmed with the personality.

28. The computer program product of claim 26, wherein the personality is acquired from a personality database.

29. The computer program product of claim 26, wherein the operations of acquiring the personality and programming the identified field-programmable gate array with the acquired personality prior to connecting the identified specific field-programmable gate array to the selected compute node include:
performing a target-to-target transfer of the personality to the identified field-programmable gate array from one of the plurality of field-programmable gate arrays in the resource pool that is already programmed with the personality.

30. The computer program product of claim 26, wherein the operation of identifying, in response to generating the offloading decision indicating to offload the new workload, a field-programmable gate array within the resource pool that is not programmed with the personality that will accelerate the new workload but has sufficient capacity to accelerate the new workload is performed only if a field-programmable gate array within the resource pool that is already programmed with the personality that will accelerate the new workload and is determined to have sufficient capacity to accelerate the new workload cannot be identified.

31. A computer program product comprising a non-transitory computer readable medium and program instructions embodied therein, the program instructions being configured to be executable by a processor to cause the processor to perform operations comprising:
receiving a composition request for a new workload;
identifying that a workload type of the new workload is able to be accelerated by an FPGA;
identifying, from a resource pool comprising a plurality of FPGAs, a FPGA that is programmed with a personality and that is determined to have capacity to accelerate the new workload, the personality providing a functional capability to accelerate the new workload and being selected from a plurality of personalities based on the identified workload type of the new workload;
connecting the identified field-programmable gate array to a compute node selected to handle the new workload; and
causing the selected compute node to process the new workload, wherein the new workload is accelerated by the field-programmable gate array connected to the selected compute node.

32. The computer program product of claim 31, wherein identifying that the workload type of the new workload is able to be accelerated by an FPGA includes determining that the new workload is a parallel processing workload.

33. The computer program product of claim 31, wherein the new workload is an internet protocol security related workload, wherein the personality that will accelerate the new workload is an internet protocol security personality, and wherein the functional capability provided to accelerate the new workload is a data authentication capability.

34. The computer program product of claim 31, wherein the new workload is a quality of service related workload, wherein the personality that will accelerate the new workload is a quality of service personality, and wherein the functional capability provided to accelerate the new workload is a packet loss reduction capability.

35. The computer program product of claim 31, wherein identifying that the workload type of the new workload is able to be accelerated by an FPGA includes:
calculating a workload processing efficiency to be gained by offloading the new workload, wherein the workload type of the new workload is identified as being able to be accelerated by an FPGA in response to the calculated gain in workload processing efficiency exceeding a first threshold.

36. The computer program product of claim 31, wherein the identified field-programmable gate array has an existing connection with a compute node that is different from the selected compute node, further comprising:
disconnecting the identified field-programmable gate array from the different compute node before connecting the identified field-programmable gate array to the selected compute node.

37. The computer program product of claim 31, further comprising:
identifying, in response to identifying that the workload type of the new workload is able to be accelerated by an FPGA, a field-programmable gate array within the resource pool that is not programmed with the personality that will accelerate the new workload but has sufficient capacity to accelerate the new workload;
acquiring the personality; and
programming the identified field-programmable gate array with the acquired personality before connecting the identified specific field-programmable gate array to the selected compute node.

38. The computer program product of claim 37, wherein the personality is acquired from one of the plurality of field-programmable gate arrays in the resource pool that is already programmed with the personality.

39. The computer program product of claim 31, further comprising:
identifying, in response to identifying that the workload type of the new workload is able to be accelerated by an FPGA, a field-programmable gate array within the resource pool that is not programmed with the personality that will accelerate the new workload but has sufficient capacity to accelerate the new workload;
acquiring the personality; and
causing the selected compute node to program the identified field-programmable gate array with the acquired personality after connecting the identified specific field-programmable gate array to the selected compute node.

40. A programming offload apparatus, comprising:
a processor; and
a memory storing one or more sets of instruction sets that, when executed by the processor, causes the processor to perform operations comprising:
receiving, by a configuration manager, a composition request for a new workload;
identifying a workload type of the new workload;
calculating a workload processing efficiency metric representing an expected performance improvement gained by offloading the new workload to a FPGA compared to processing the new workload using a central processing unit (CPU);
generating an offloading decision indicating either to offload the new workload to a FPGA in response to the workload processing efficiency metric meeting or exceeding a predetermined efficiency threshold, or to not offload the new workload to the FPGA in response to the workload processing efficiency metric failing to exceed the predetermined efficiency threshold;
selecting and configuring a compute note in response to the offloading decision, wherein:
when the offloading decision indicates to offload the new workload to an FPGA, configuring the compute node comprises identifying, from a resource pool comprising a plurality of FPGAs, a FPGA that is programmed with a personality and that is determined to have capacity to accelerate the new workload, the personality providing a functional capability to accelerate the new workload and being selected from a plurality of personalities based on the new workload, and connecting the FPGA programmed with the personality to the selected compute node; and
when the offloading decision indicates not to offload the new workload to an FPGA, configuring the compute node comprises composing, by the configuration manager, the selected compute node with required resources enabling the selected compute node to process the new workload without FPGA acceleration; and
causing the configured compute node to process the new workload.
